(19) United States
(12) Patent Application Publication
(10) Pub. No.: US 2007/0096663 A1
(43) Pub. Date: May 3, 2007

(54) Apparatus integrated with cold light emergency lamp and cold light exit sign

(76) Inventors: ChiWai Wong, Hong Kong (CN); ChiKwong Li, Hong Kong (CN)

Correspondence Address: ALIX YALE & RISTAS LLP, 750 MAIN STREET, SUITE 1400, HARTFORD, CT, 06103, US

(21) Appl. No.: 11/376,861

(22) Filed: Mar. 16, 2006

(30) Foreign Application Priority Data
Oct. 28, 2005 (CN) 200510118484.0

(51) Int. Cl. H05B 39/00

(52) U.S. Cl. 315/312

(57) ABSTRACT

A cold light emergency lamp, a cold light exit sign, a centralized control box of cold light emergency lamp and cold light exit sign, and an apparatus integrated with cold light emergency lamp and cold light exit sign are disclosed. A plurality of sockets are arranged on the body of the centralized control box for being inserted by power line plugs of a plurality of groups of cold light exit signs and cold light emergency lamps. The centralized control box further comprises: a battery; a micro control unit connected to the battery for detecting the battery regularly; a cold light element drive circuit connected to the micro control unit for performing drive under the control of the micro control unit. Each of the cold light emergency lamps and the cold light exit signs has a power line plug for inserting in a socket of the centralized control box so that the cold light emergency lamps and the cold light exit signs are electrically connected to the cold light element drive circuit. According to the present invention, a plurality of groups of cold light emergency lamps and cold light exit signs are separably integrated into a centralized control box so that not only the plurality of groups of cold light emergency lamps and cold light exit signs can be made a centralized control but also the volumes of the cold light emergency lamps and cold light exit signs can be greatly reduced and the cold light emergency lamps and cold light exit signs may be flexibly placed on any position in any angle according to emergent site.

### FIELD OF THE INVENTION

The present invention relates to an emergency illumination device, particularly to an integrated apparatus with cold light emergency lamp and cold light exit sign.

### DESCRIPTION OF THE PRIOR ART

A fire emergency lamp and a fire emergency exit sign are widely used in commercial, industrial and civil buildings. They are essential fire equipments, and must be used together as a whole set for each of buildings. However, they are designed at present mostly as independent products, which have the following deficiencies:

1. The light source of a conventional emergency lamp as shown in FIG. 1 generally is provided with an incandescence bulb, which has disadvantages such as high current, short lifetime, scatter bulb ray and poor brightness, and a sealed lead-acid battery to satisfy the time request of the emergency illumination in conformity to fire prescriptions. Such kind of battery is heavy and large. It may be a burden or bring about an inconvenience to a building with a finite space. Moreover, such kind of battery has low reliability, high product cost and only one or two years of lifetime.

2. A conventional exit sign as shown in FIG. 2 comprises a power source and a drive circuit. That makes the product heavy and noisy, and raises the cost and the difficulty of production.

3. Both the emergency lamp and the emergency exit sign concerned above are further equipped respectively with a relative heavy and large transformer. These produce the same questions as described above.

Accordingly, the conventional emergency sign and emergency lamp are not inconvenient in practice due to the separate structure, the weight and volume, and not in consistent with the relative fire equipment installation regulations.

U.S. Pat. No. 6,142,648 discloses an emergency lighting unit/exit sign combination device. However, according to the device, the emergency lighting unit is fixed on the two sides of the sign and rotates only in level direction.

Chinese patent CN 2483590Y discloses a LED emergency illumination device with its own power source and drive circuit. It is still large and heavy, and should be cooperated with other indication signs in practice.

In addition, U.S. Pat. No. 5,729,925 discloses an emergency exit sign. According to this device, LEDs are arranged in two rows on the center of the sign box and are connected in series. As we know, once any LED fails, the whole of LED string connected in series will be not operating normally. So the reliability of device could not be satisfied with practical requirements.

### SUMMARY OF THE INVENTION

In order to solve the above problems, it is an object of the present invention to provide a centralized control box for a cold light exit sign and a cold light emergency lamp, which is separably connected with a plurality of groups of cold light exit signs and cold light emergency lamps, for realizing a centralized drive and control of the plurality of groups of cold light exit signs and cold light emergency lamps.

To realize the above object, a centralized control box is proposed, which comprises: a plurality of sockets arranged on the body of the centralized control box for being inserted by power line plugs of a plurality of cold light exit signs and/or cold light emergency lamps; a battery; a cold light element drive circuit; and a micro control unit connected to the battery for regularly detecting the battery at predetermined time and to the cold light element drive circuit for controlling the cold light element drive circuit; wherein the cold light element drive circuit is electrically connected to the cold light exit signs and the cold light emergency lamps for driving the cold light exit signs and the cold light emergency lamps to emit light under the control of the micro control unit, when the power line plugs are inserted in the sockets.

Preferably, the centralized control box is also provided with a testing switch, a fuse tube and indicating devices respectively for indicating the operation states of the mains voltage, the battery, the cold light exit signs and the cold light emergency lamps.

Preferably, the micro control unit detects and controls the charge time and discharge time of the battery via a crystal oscillator, detects the voltage and current of each of the cold light exit signs and the cold light emergency lamps via an A/D converting circuit, indicates the cold light element operation state of each of the cold light exit signs and the cold light emergency lamps via the indicating light according to a preset program, regularly detects the battery and the cold light element operation condition via a read only memory storing a timing program and controls the cold light element drive circuit at predetermined time.

Preferably, the battery is a nickel-cadmium battery or a nickel-metal hydride battery; and the indicating device is a LED or a backlight liquid crystal display unit.

Preferably, the cold light element drive circuit is an IC type DC-AC converting circuit.

Preferably, the IC type DC-AC converting circuit is an integrated circuit for driving a large electroluminescent sheet, which directly rectifies the mains voltage to an AC voltage of 100-120V and 400-600 Hz so as to drive the large electroluminescent sheet to emit light.

Preferably, the IC type DC-AC converting circuit is an integrated circuit for driving a medium electroluminescent sheet, which converts a DC voltage to a positive-negative symmetrical AC voltage of 80-100v and 400-600 Hz so as to drive the medium electroluminescent sheet to emit light.

Preferably, the IC type DC-AC converting circuit is an integrated circuit for driving a small electroluminescent sheet, which converts a DC voltage to a positive AC voltage of approximately triangular with a voltage peak of 100-130V and a frequency of 400-600 Hz so as to drive the small electroluminescent sheet to emit light.

Preferably, the IC type DC-AC converting circuit is an integrated circuit for driving LED, which converts a low DC voltage to a voltage that is suitable for driving LED to emit light with a high chopping frequency of above 20 kHz.

Another object of the present invention is to provide a cold light exit sign with no power source and drive circuit, which is separably connected to the above centralized control box, and emits light independently regardless of whether other cold light exit signs are disconnected or not. It can be placed on any position in any angle according to installation conditions. Especially, it is easily combined with a cold light emergency lamp as a whole set.

To realize the above object, the cold light exit sign is provided with a power line plug that is used for inserting in a socket of a centralized control box so as to electrically connect the cold light exit sign with a cold light element drive circuit. The cold light exit sign does not comprise any other electronic parts except for cold light element.

Preferably, the cold light exit sign includes a sign plate carrying the power line plug and a light baffle-board with a plurality of LEDs arranged behind the sign plate. Preferably, said plurality of LEDs are arranged in a row on an upper side or a lower side of the light baffle-board if the area of the cold light exit sign is small. Preferably, said plurality of LEDs are arranged in two rows respectively on an upper side and a lower side of the light baffle-board if the area of the cold light exit sign is medium. Preferably, said plurality of LEDs are arranged in four rows respectively on an upper side, a lower side and two sides of the light baffle-board if the area of the cold light exit sign is large.

Preferably, the luminescent portion of the cold light exit sign is an electroluminescent sheet with the power line plug. Preferably, the electroluminescent sheet is printed with one of pattern and character made from an electroluminescent powder or their combination.

A further object of the present invention is to provide a cold light emergency lamp with no power source and drive circuit, which is connected to the above centralized control box separably, and emits light independently regardless of whether other cold light emergency lamps are in disorder or not. It may be placed on any position in any angle according to emergent site. Especially, it is easily combined with a cold light exit sign as a whole set.

To realize the above object, the cold light emergency lamp is provided with a power line plug that is used for inserting in a socket of a centralized control box so as to electrically connect the cold light emergency lamp with a cold light element drive circuit. The cold light emergency lamp does not comprise any other electronic parts except for cold light element.

Preferably, the cold light emergency lamp is provided with only a LED encapsulation. Preferably, the LED encapsulation includes a LED directly spot-welded on a circuit board in the form of a chip and enveloped with a phosphor powder and a transparent epoxy resin.

A fourth object of the present invention is to provide an integrated apparatus with cold light emergency lamps and cold light exit signs, wherein each of emergency lamps and exit signs is no longer provided with its own power source and drive circuit. They are all driven and controlled by means of a centralized control box.

To realize the above object, the apparatus comprises:

a centralized control box including a plurality of sockets arranged on the body thereof for being inserted by power line plugs of one or more of cold light exit signs and/or one or more of cold light emergency lamps; a battery; a cold light element drive circuit; and a micro control unit connected to the battery for regularly detecting the battery at predetermined time and to the cold light element drive circuit for controlling the cold light element drive circuit; and

one or more groups of cold light emergency lamps and cold light exit signs placed on the area away from the centralized control box and carrying power line plugs for inserting in sockets of the centralized control box, wherein the cold light emergency lamps and the cold light exit signs do not comprise any other electronic parts except for cold light elements;

wherein the cold light element drive circuit is electrically connected to the cold light exit signs and the cold light emergency lamps for driving the cold light exit signs and the cold light emergency lamps to emit light under the control of the micro control unit, when the power line plugs are inserted in the sockets.

The scheme of making a centralized control for the emergency lamp and exit sign according to the present invention is characterized by the following facts:

1. The drive circuit and the battery are arranged in the centralized control box, the body of the box is provided with a plurality of groups of sockets for being inserted by driving down-lead plugs of the exit signs and the emergency lamps.

2. The power source and drive circuit are arranged together in the centralized control box, which can simultaneously drive the plurality of groups of exit signs and emergency lamps, resulting in a more convenient operation and maintain for the equipment.

3. EL or LED is employed as the exit sign and no power source and drive circuit are arranged in the body of the exit sign so that the exit sign is light in weight and is not noisy.

4. A plurality of groups of LED chip encapsulations are employed as the cold light source in the emergency lamp so that the emergency lamp has a small volume, strong and wide illumination range.

According to the present invention, a plurality of groups of cold light emergency lamps and cold light exit signs are separably integrated into a centralized control box so that not only the plurality of groups of cold light emergency lamps and cold light exit signs can be made a centralized control but also the volumes of the cold light emergency lamps and cold light exit signs can be greatly reduced and the cold light emergency lamps and cold light exit signs can be installed flexibly.

### BRIEF DESCRIPTION OF THE DRAWINGS

FIG. 1 is a schematic diagram of a conventional emergency lamp.

FIG. 2 is a schematic diagram of a conventional exit sign.

FIG. 3A is a schematic diagram showing an emergency lamp according to the present invention.

FIG. 3B-3C are illustrative diagrams showing the LED of the emergency lamp according to the present invention.

FIG. 4A-4D are structure diagrams showing an exit sign according to the present invention (LED).

FIG. 4E is a structure diagram showing the exit sign according to the present invention (the EL sheet, namely the electroluminescence sheet).

FIG. 5A is a schematic diagram showing a control box according to the present invention.

FIG. 5B is a block diagram showing a control circuit of the control box according to the present invention.

FIG. 6 is a schematic diagram showing an apparatus integrated with the emergency lamp and the exit sign according to present invention.

FIG. 7 shows an AC-DC converting circuit according to the present invention.

FIG. 8 shows a pulsating constant current charging circuit according to the present invention.

FIG. 9 shows a mains-fault detecting circuit according to the present invention.

FIG. 10 shows a drive circuit of a large electroluminescent sheet according to the present invention.

FIG. 11 is a diagram showing a waveform of output voltage of the circuit of the large electroluminescent sheet according to the present invention.

FIG. 12 shows a drive circuit of a medium electroluminescent sheet according to the present invention.

FIG. 13 is diagram showing a waveform of output voltage of the circuit of the medium electroluminescent sheet according to the present invention.

FIG. 14 shows a drive circuit of a small electroluminescent sheet according to the present invention.

FIG. 15 is a diagram showing a waveform of output voltage of the circuit of the small electroluminescent sheet according to the present invention.

FIG. 16 shows a LED drive circuit according to the present invention.

FIG. 17 is a general drawing showing the circuit according to the present invention.

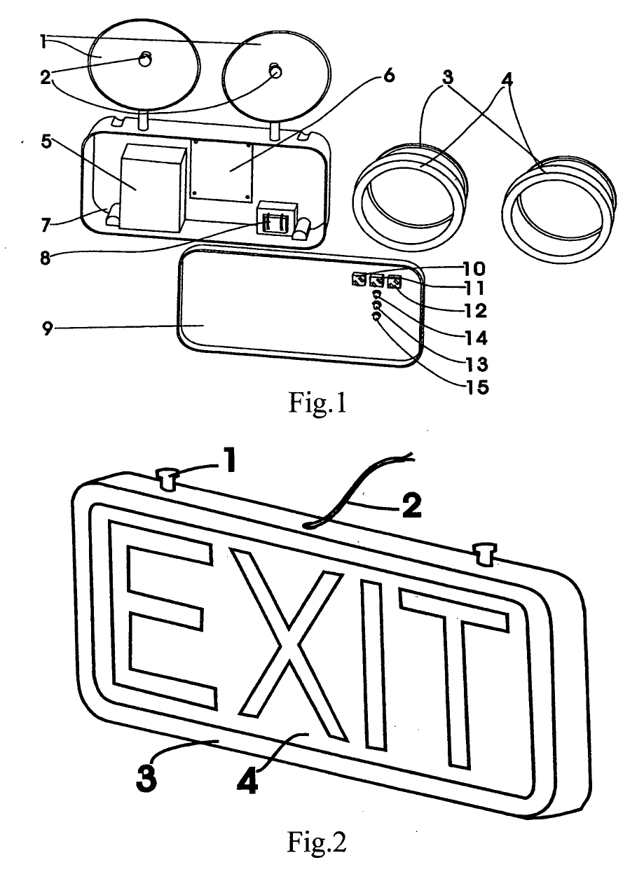

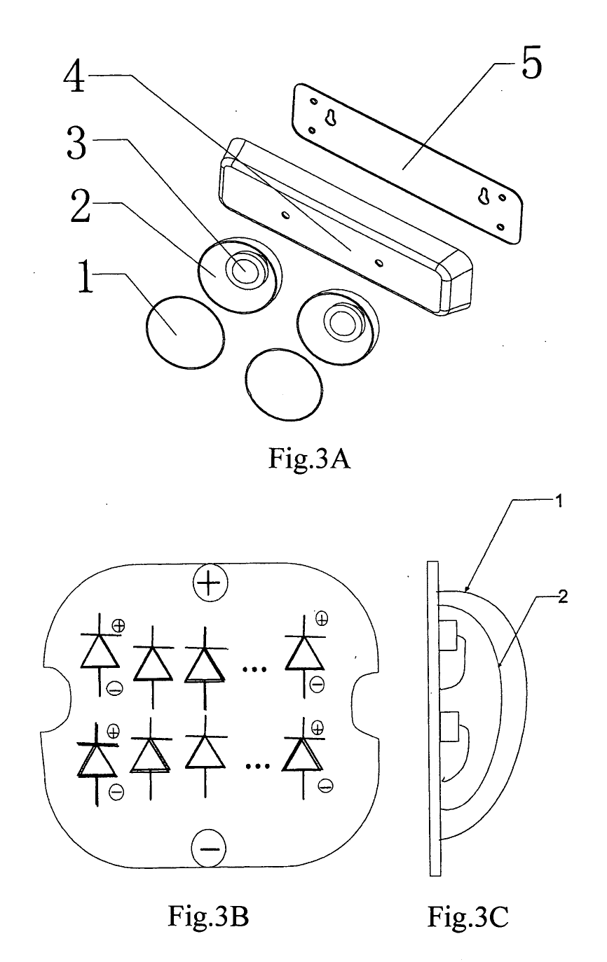

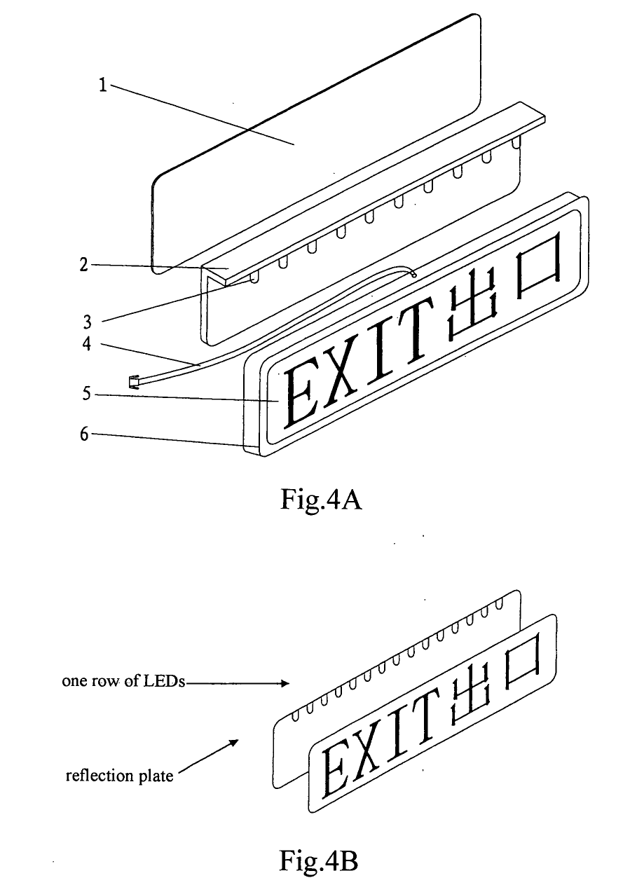

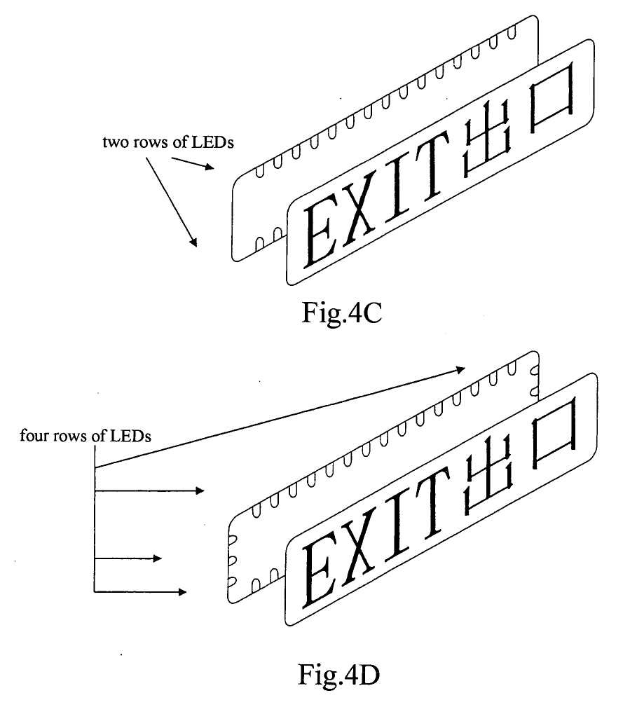

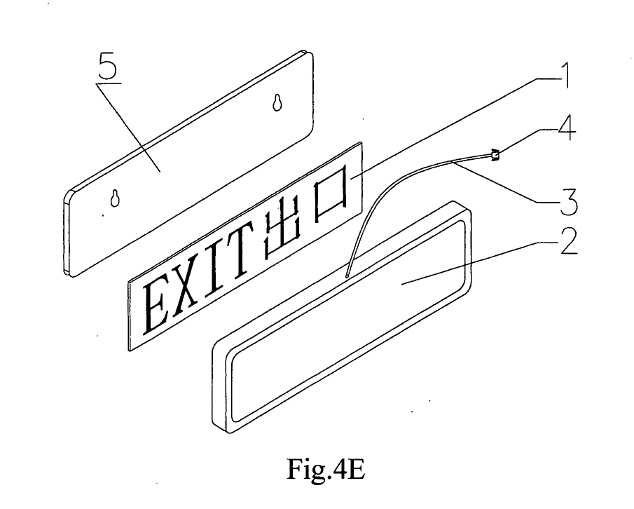

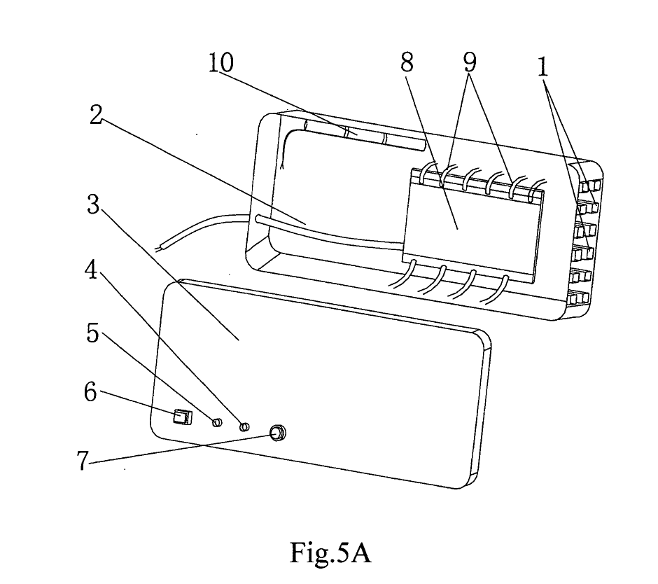

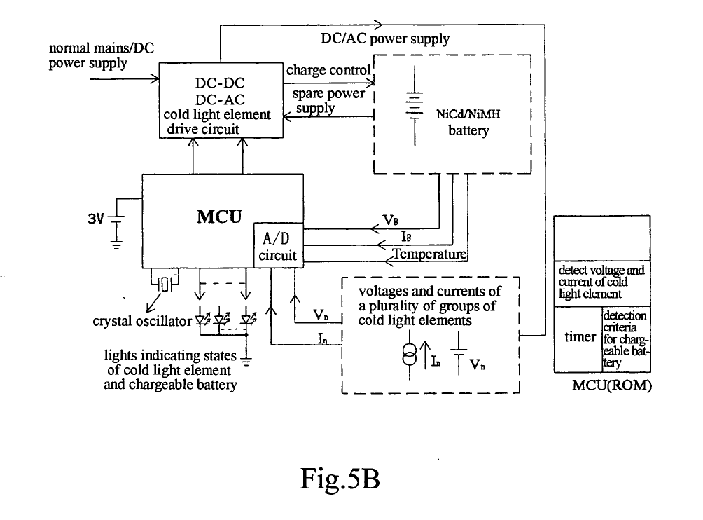

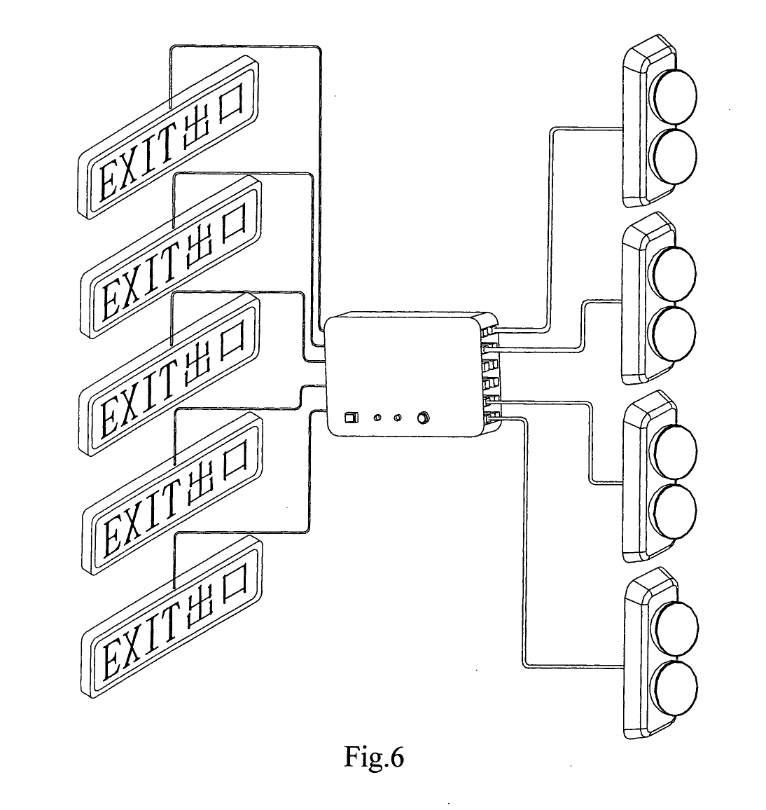

Wherein, reference signs will be described as follows:

| | | |
|---|---|---|
| In FIG. 1: | | |
| 1-lamp rear cover | 2-Lamp bulb | 3-lamp shade |
| 4-lamp front cover | 5-battery | 6-PCB board |
| 7-rear cover of the board body | 8-transformer | |
| 9-front cover of the board body | 10-switch | |
| 11-test switch | 12-switch | 13-charge indicator |
| 14-fault indicator | 15-mains indicator | |
| In FIG. 2: | | |
| 1-lifting eye | 2-power line | 3-body |
| 4-EL sheet (or information mark board) | | |
| In FIG. 3A: | | |
| 1-transparent epoxy resin | 2-lamp socket | 3-LED encapsulation |
| 4-front cover of the socket | 5-rear cover of the socket | |
| In FIG. 3C: | | |
| 1-transparent epoxy resin | 2-luminescent powder | |
| In FIG. 4A: | | |
| 1-rear cover | 2-PCB board (light baffle-board) | 3. LED |
| 4-drive power line | 5-mark sign | 6-frame |
| In FIG. 4E: | | |
| 1-mark sign (EL sheet) | 2-frame | 3-drive power line |
| 4-plug | 5-rear cover | |
| In FIG. 5: | | |
| 1-socket | 2-box body | 3-front cover |
| 4-charging state indicating light | 5-mains indicator | |
| 6-test switch | 7-fuse tube | 8-PCB board |
| 9-drive line | 10-spare battery. | |

### DESCRIPTION OF THE PREFERRED EMBODIMENTS

Different from the conventional design method as described above, a centralized control for emergency lamps and exit signs of a whole building is executed according to the present invention. Namely, a plurality of groups of emergency lamps and exit signs simultaneously driven by a control box and several control boxes are used to drive all fire emergency equipments of the whole building. Moreover, all emergency lamps and exit signs are respectively introduced to the control boxes only by one power line, and plugs provided on the end of the power lines are respectively inserted in preset sockets of the control boxes.

An emergency lamp and an exit sign that may be placed on a site away from the centralized control box and driven by the centralized control box will be described in details with reference to FIGS. 3A-4E hereinafter.

Referring to FIG. 3A, a new type of LED (light-emitting diode) is employed as the emergency lamp and is mounted in the housing of the emergency lamp due to its relative small volume, strong and wide illumination range and long lifetime. A plurality of the LEDs are assembled as shown in FIGS. 3A-3B in a single enclosure which doesn't include any other electronic parts.

Referring to FIG. 3C, the LED employed as the emergency lamp, which is installed in the emergency lamp in the form of chip, is directly spot-welded on a circuit board and enveloped with phosphor powder and then enveloped with transparent epoxy resin.

Either a LED or an electroluminescent sheet directly emitting light may be employed as the exit sign, namely the exit indication sign.

The LEDs together with a light baffle-board are mounted behind the sign, as shown in FIG. 4A. The light emitted by the LEDs behind the sign is reflected by the baffle-board such that the pattern and characters with uniform brightness are displayed on the surface of the sign. The degree of brightness of the sign is in direct proportion to the number of LEDs mounted behind the sign.

Further, a plurality of rows of LEDs can be arranged depending on the shape and area of the exit sign. For example, a single row of backlights can be used when the area of the exit sign is small, as shown in FIG. 4B, double rows of backlights can be used when the area of the exit sign is medium, as shown in FIG. 4C, and four rows of backlights can be used when the area of the exit sign is large, as shown in FIG. 4D.

FIG. 4E shows the electroluminescent sheet carrying patterns and characters in the exit sign. Patterns and characters made from the electroluminescent powder are printed on the film (EL sheet) by the screen printing technology. The exit sign can be directly driven by the centralized control box's AC 100-130V power via the connectors.

The centralized control box will be described in details with reference to FIGS. 5A-5B below.

Referring to FIG. 5A, a drive circuit, a rechargeable battery, a charging state indicating light, an mains indicating light, a testing switch, a fuse tube, one or more groups of indicating lights and a micro control unit (MCU) and so on are mounted in the centralized control box. A NiCd/NiMH rechargeable battery (nickel-cadmium/nickel-metal hydride battery) pack can be employed as the rechargeable battery. The micro control unit is used for detecting the rechargeable battery pack regularly, controlling and driving the DC-AC power circuit of a plurality of groups of cold light emergency lamps and fire exit signs.

Referring to FIG. 5B, in the control circuit, the micro control unit detects and controls the charge time and discharge time of the rechargeable battery pack via a timing circuit based on a crystal oscillator. The micro control unit is provided with an A/D converting circuit for detecting the normal voltage and current of the cold light lamp and the cold light exit sign. The cold light element operation state of the external cold light lamp is indicated by an indicating light according to a preset program. A LED light or a backlight LCD can be employed as the message indicator. The micro control unit is also provided with a read only memory (ROM) storing a timing program so that the micro control unit can test the rechargeable battery and normal operation condition of cold light elements and control the cold light element drive circuit according to the timing program.

The number and specification of the centralized control boxes are designed according to the total number of exit signs and emergency lamps of the whole building. A number of sockets are installed on each centralized control and the number is determined according to actual needs. Power lines of all exit signs and emergency lamps are introduced to the centralized control box. The mains voltage 220V/110V is applied to the control box. Several control boxes are arranged together so that the operation and maintenance can be carried out conveniently and integratedly.

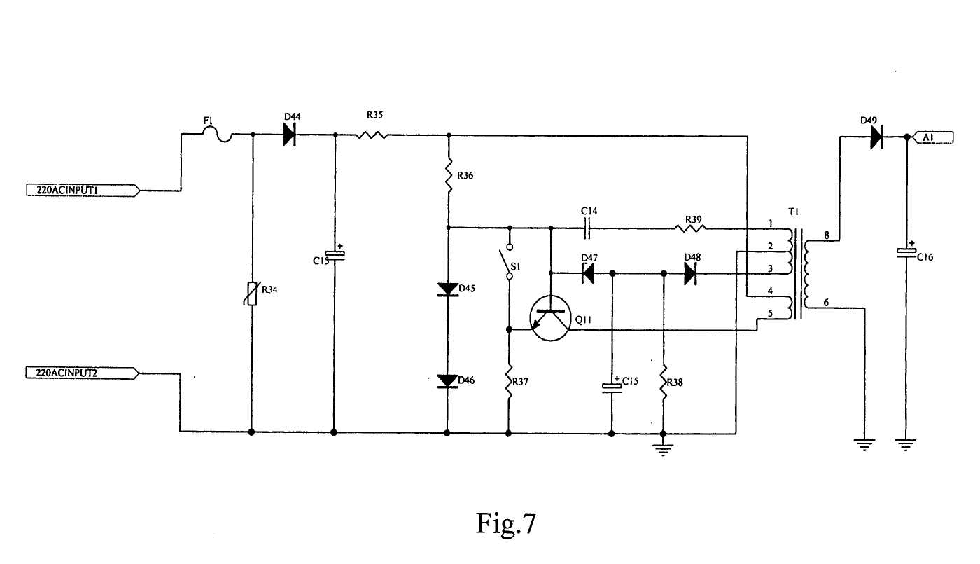

Referring to FIG. 6, it shows the schematic diagram of the integrated device of the emergency lamps and the exit signs according to the present invention. One or more groups of emergency lamps and one or more groups of exit signs are respectively arranged on two sides of the control box.

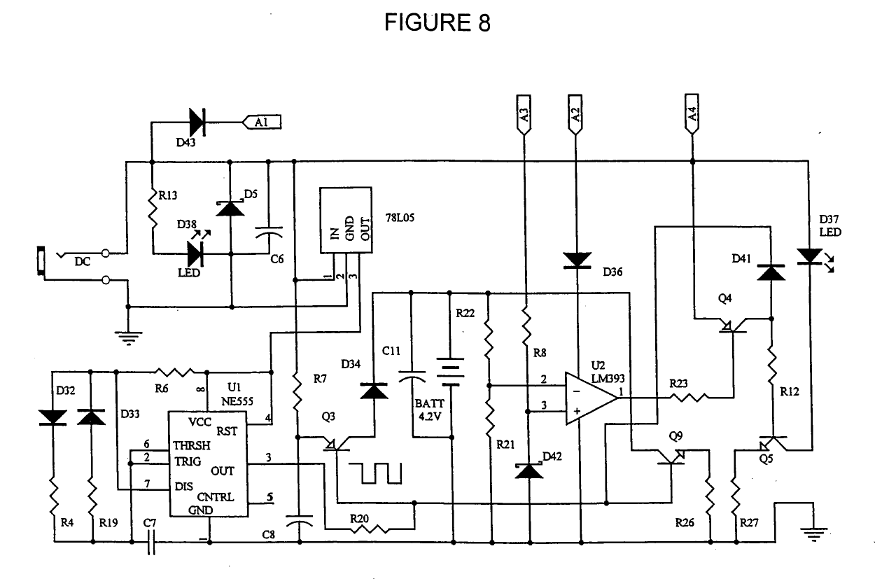

Hereinafter, the electronic circuit of the present invention will be described with reference to FIGS. 7-17 in details.

FIG. 7 shows an AC-DC converting circuit.

Characteristics: a new type of small size, high efficiency, stable operation and low cost circuit is employed to convert the AC-DC voltage. The conventional power transformer with large size, low efficiency and high cost used in current applications is replaced.

Principle:

After rectified by a rectifier diode D44 and filtered by C13 and limited by R35, the 220V/110V mains is converted into an unregulated voltage of 250V (a fuse tube F1 is connected in series with the input end of the mains for overcurrent protection; a varistor R34 and F1 constitute an overvoltage protection circuit for the mains). The unregulated voltage provides a bias voltage of 1.4V applied to the base electrode of Q1 via a resistor R36 and clamping diodes D45 and D46. A feedback voltage is induced to generate by the positive feedback winding by Q11 collector current flows through a primary winding of a switching transformer T1. The feedback voltage is applied between the base and the collector of Q11 via R39 and C14 so as to make the positive bias voltage of Q11 rise and the collector current of Q11 increase. Accordingly, the emitter current is increased due to the increase of the collector current, and the electric potential between two ends of R37 is increased, so that Q11's emitter voltage increases and Q1 becomes cut-off from saturation. The magnetic field energy stored in the primary winding of the switch transformer T1 is changed to a low AC voltage after coupling with the secondary winding of the switching transformer. After rectified by D49 and filtered by C16, the AC voltage is converted into a DC voltage for supplying to the charging circuit and the DC-AC converting circuit for the EL sheet.

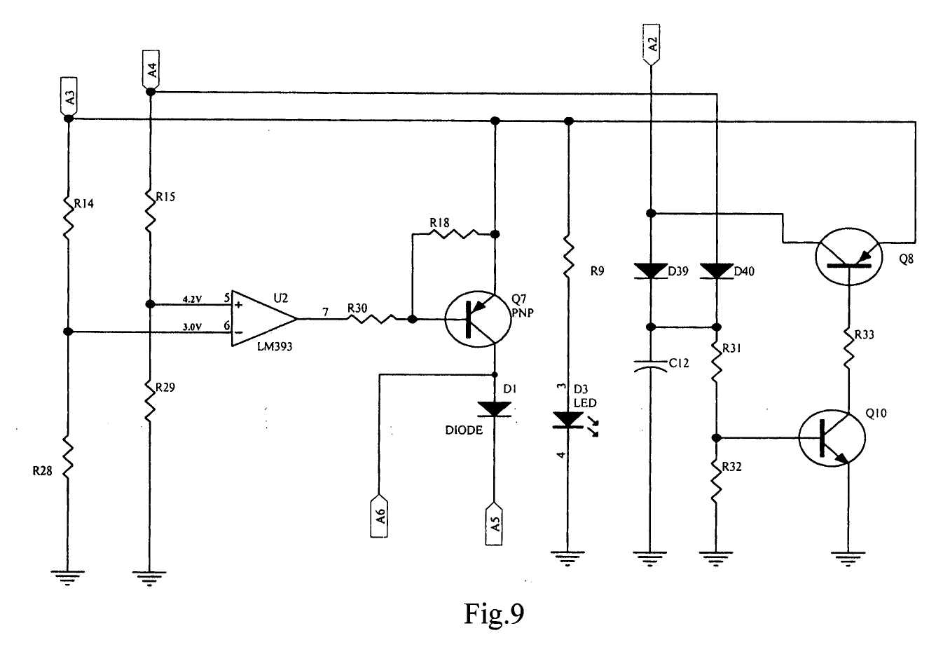

FIG. 8 shows the pulsating constant current charging circuit.

Characteristics: 1. Constant_current charging and discharging circuit; 2. Charge time is 1.5 second and discharge time is 0.5 second; 3. The voltage of the battery is detected for proper battery conditions. 4. A nickel-cadmium cell is employed to replace the conventional rechargeable battery (namely, the lead-acid cell), further reducing the cost.

Principle: When connected with the external power source, output is diverted to several paths. The drive circuit is supplied power source via one path, a Zener diode D5 is used to stabilize the voltage. R13 and D38 constitute an incoming power indicating circuit. C6 function as a filter capacitor for filtering the alternating current component. U1 (NE555IC) and R4, R19, C7, R6, D32 and D33 constitute an oscillator, which outputs a square wave of high level of 0.5 second and low level of 15 second during one period. IC 78L05 with three ends functions to provide a stable voltage to the time base IC NE555. R7 is employed as a current limiting resistor, and R20, Q3, C8, Q9 and R26 constitute the charging and discharging circuit. Q9 is turned on and Q3 is cut off when pin 3 of NE555 (U1) are in high level, while Q9 is cut off and Q3 is turned on when pin 3 of NE555 are in low level. R20 is employed as a bias resistor of Q3, the value of which determines the magnitude of the charging current. D34 is used for isolation. C11 is used for filtering the alternating current component. The battery is a storage element. R22, R21, R8, D42 and U2 constitute a voltage comparator. R23 is employed as a bias resistor of Q4. R12, Q5, D37 and R27 constitute a charging indicating circuit. D41 is used for isolation. D37 twinkles in the charging frequency when the battery is charged to a predetermined value, which shows that the battery is ready to complete charging (the voltage is detected during discharging). When the battery is charged to the saturation value of 4.2V, the first pin of U2 is low level, Q4 is turned on, Q5 is turned on, and Q3 is cut off, and so the charging to the battery is stopped in order to protect the battery from overcharging while D37 always emits light, which indicates that the battery is in a state of saturation.

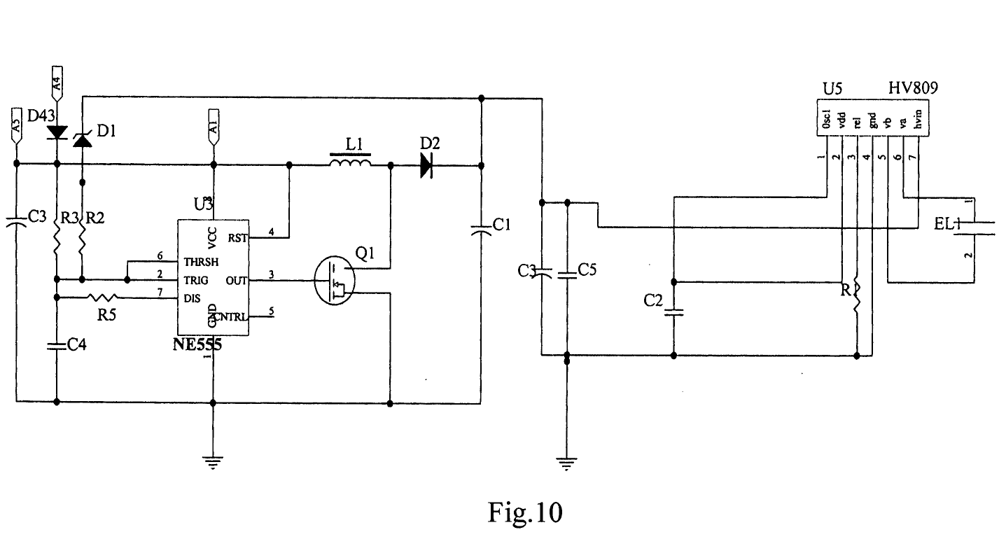

FIG. 9 shows the mains-fault detecting circuit.

Characteristics: 1. Dedicated electronic circuit. 2. Accuracy is high, cost is low and the conventional mechanical converting switch needn't to be used; 3. Operating lifetime is long and operation is stable and reliable.

Principle: R14, R15, R28, R29 and U2 constitute a voltage comparator. R30, R18 and Q7 constitute a control circuit. R9 and D3 constitute a discharging indicating circuit. D39, D40, C12, R31, R32, R33, Q8 and Q10 constitute a power-broken converting circuit. When the power source is supplied, the current flows through D40, R31 and Q10 to control Q8 to turn on and U2 to operate, and the seventh pin of U2 is in a high level to make Q7 cut off. When no power source is supplied, C12 is discharged to make Q10 and Q8 turn on. At this time, the fifth pin of the voltage comparator has an electric potential lower than that of the sixth pin, and thus the seventh pin is in a low level to make Q7 turn on. Turn on of Q7 connects the power source to operate the drive circuit.

The common characteristics of the above drive circuit are:

1. The current and power consumption is low and the efficiency of converting DC into AC is above 85%;

2. The volume is small and the cost is low;

3. The conventional heavy transformer is replaced and the noise caused by the high frequency transformer is eliminated.

The drive area is in a range of 1 to 40 square inches.

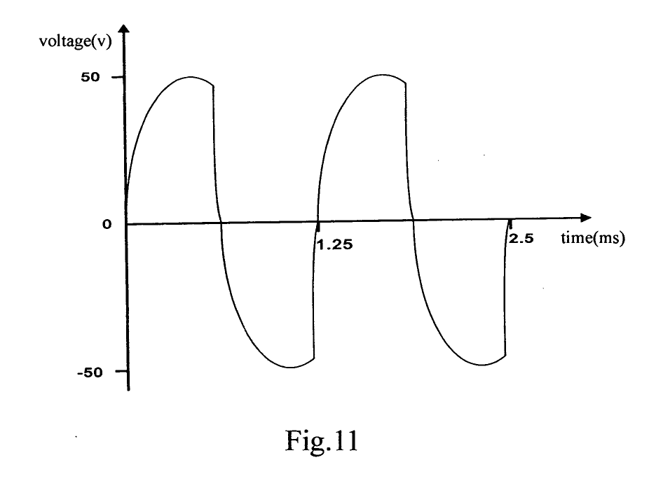

The cold light element drive circuit will be described in details with reference to FIGS. 10-16 as follows.

The cold light element drive circuit is an IC type DC-AC converting circuit, which is the integrated circuit of the Electroluminescent sheet for driving the DC-AC circuit of the Electroluminescent sheet in case that the Electroluminescent sheet is employed as the exit sign, or is the integrated drive circuit of LED for driving the LED in case that the LED is employed as the exit sign.

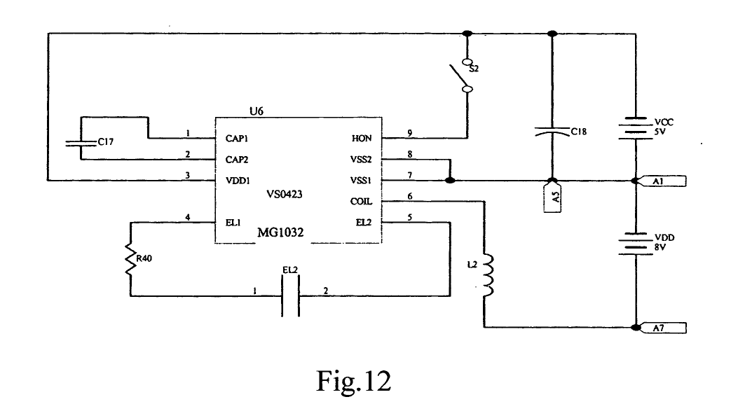

Referring to FIGS. 10 and 11, the integrated circuit for the large EL sheet directly rectifies the mains and converts the high DC voltage to an AC voltage of 100-120V and 400-600 Hz so as to drive the large electroluminescent sheet.

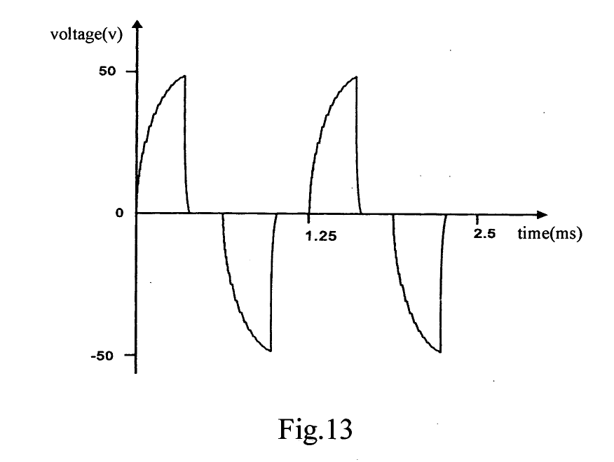

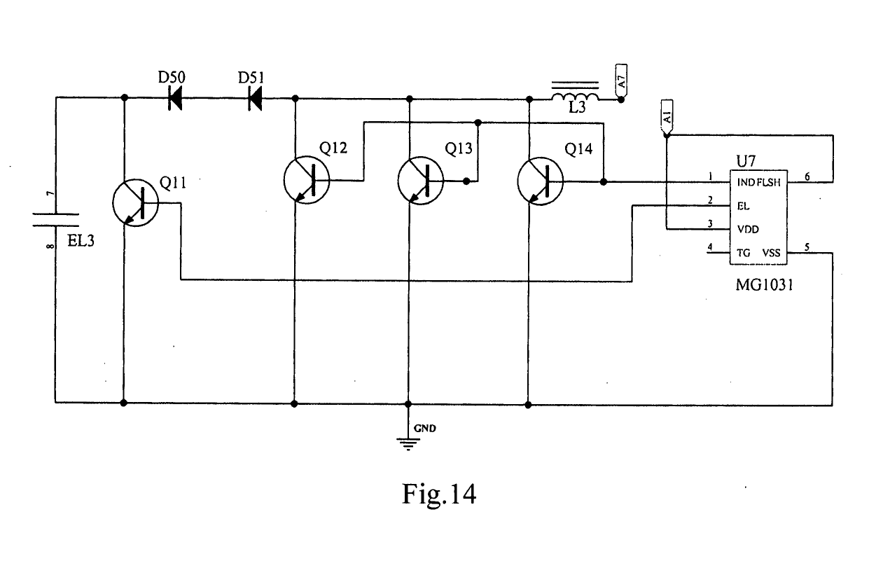

Referring to FIGS. 12 and 13, the integrated circuit for the medium EL sheet converts the DC voltage to a positive-negative symmetrical AC voltage of 80-100V and 400-600 Hz so as to drive the medium electroluminescent sheet.

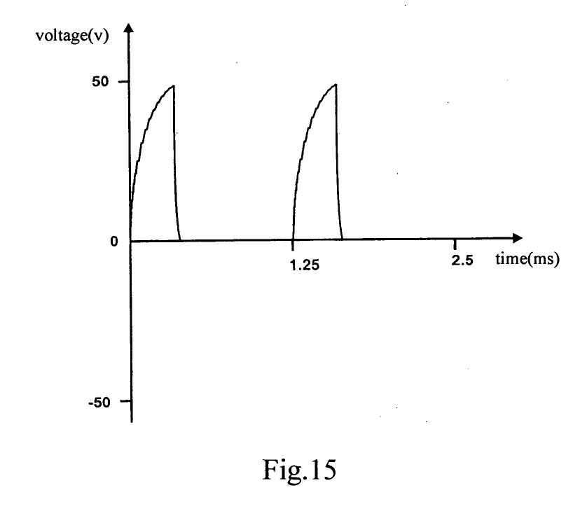

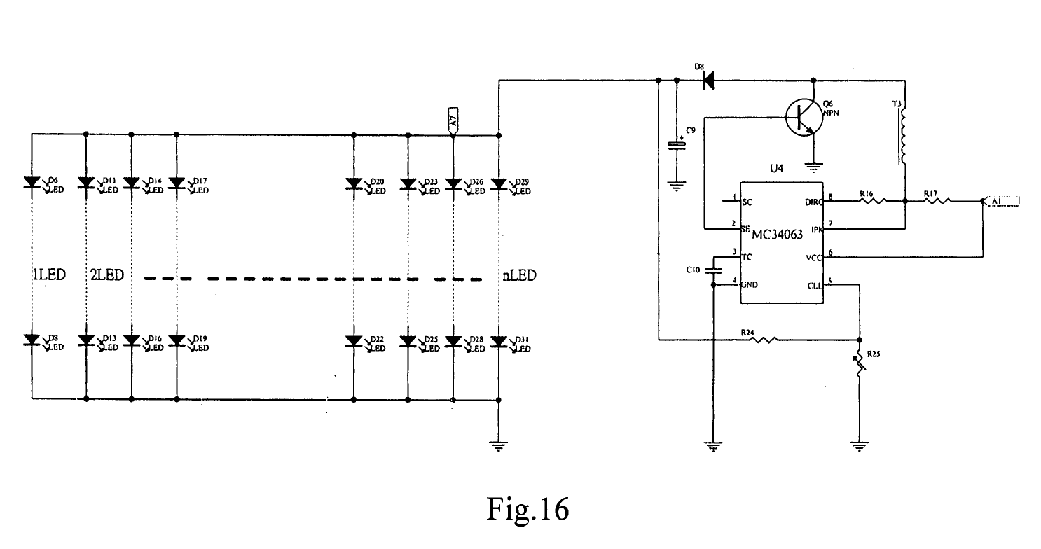

Referring to FIGS. 14 and 15, the integrated circuit for the small EL sheet converts the DC voltage to a positive AC voltage of approximately triangular with a voltage peak of 100-130V and a frequency of 400-600 Hz so as to drive the small electroluminescent sheet.

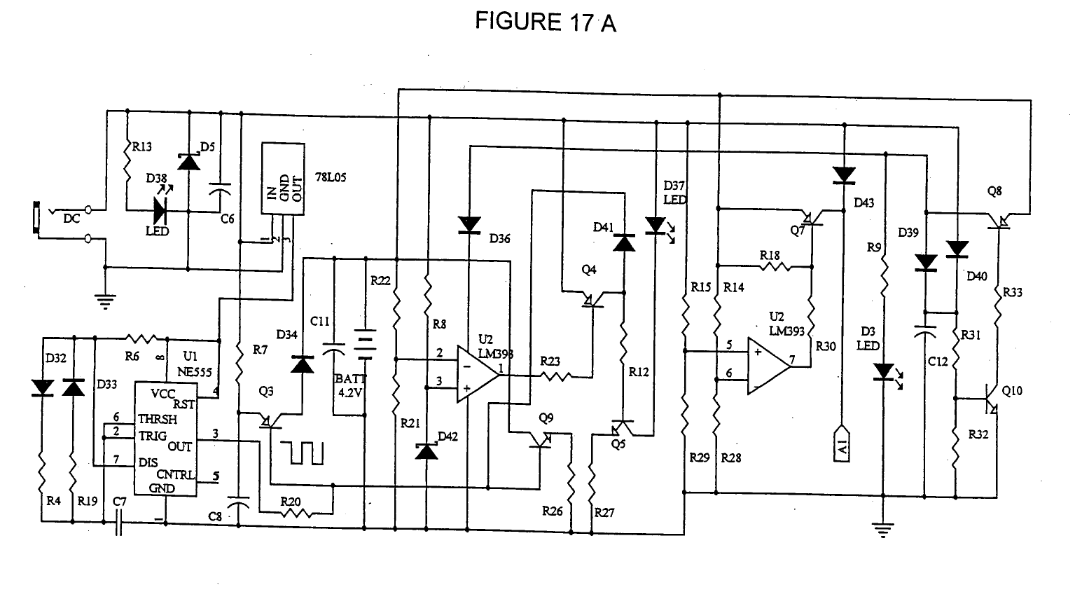

Referring to FIG. 16, the integrated drive circuit for LED converts a low DC voltage output from the nickel-cadmium or nickel-metal hydride cell, for example, 3.6V or 4.8V (depends on the number of NiCd/NiMH cells) to a voltage, which is suitable for driving the LED, with a high chopping frequency of above 20 kHz.

The integrated circuits for driving the large EL sheet, the medium EL sheet, the small EL sheet and the LED will be described in details as follows.

The drive principle of driving the large EL sheet is shown in FIG. 10. In FIG. 10, C3 is employed as a filter capacitor and D43 is employed as an isolation element. R3, R2, R5, D1, C4, L1, Q1 and U3 NE555IC constitute an unsteady-state oscillator for outputting a rectangular square wave pulse of 20 kHz, which is rectified by D2 to output a voltage of 150V and 50 mA for driving the drive circuit. C3 and C5 are employed as a high voltage filter capacitor for filtering the alternating current component to make the output voltage smooth. C2, R1 and HV809 constitute a drive circuit whose drive voltage comes from the boost circuit of U2NE555 (DC-DC inverting circuit). U5HV809IC directly converts the high DC voltage to a high AC voltage with high frequency to drive the EL sheet to emit light. This AC voltage is 100-120V and has a frequency of 400-600 HZ. The corresponding waveform is shown in FIG. 1. The drive area is in a range of 30 to 40 square inches.

The principle of driving the medium EL sheet is shown in FIG. 12. U6 (Type of U6 is MG1032 IC), C17, R40, S2, VCC (5V), VDD (8V) and L2 constitute the drive circuit of the EL sheet. C7 is the external capacitor of interior oscillator circuit of IC (U6). When VCC 5V and VDD 8V are applied to IC (U6), VCC 5V is applied to the IC, and VDD 8V is applied to the IC via L2. Energy is stored in the inductor L2, and then the positive-negative symmetrical sine wave type voltage outputted from the IC drives the EL sheet to emit light. This voltage is 80-100V and has a frequency of 400-600 HZ. The corresponding waveform is shown in FIG. 13. The maximum drive area is 10 square inches.

The principle of driving the small EL sheet is shown in FIG. 14. U7 (Type of U7 is MG1031 IC), Q11, Q12, Q13, Q14, D50, D51 and L3 constitute a drive circuit for the small EL sheet. When the IC is connected to the power source via the third pin, a rectangle square wave is outputted from the interior unsteady circuit of the IC via the first pin and the second pin thereof, then the wave is magnified by Q11, Q12, Q13, and Q14, isolated by D50 and D51, and an approximately triangle wave is output from the collector of Q11 for driving the EL sheet to emit light. This voltage has a peak Vpp of 100-130V and a frequency of 400-600 HZ. The corresponding waveform is shown in FIG. 15. The maximum drive area is 2 square inches.

FIG. 16 shows the LED drive circuit.

Characteristics: 1. LED is employed as a lighting source, resulting in low power consumption and low cost; 2. Compared with other lighting source, LED has a superior illumination performance; 3. Compared with the fluorescent tube which is large in size, high power consumption and high cost, the size of LED is much smaller, convenient and reliable in use.

Principle: U4MC34063, R25, R24, C10, Q6, T3, R16 and R17 constitute a voltage boost circuit. Q7 is cut-off and D3 is reverse-biased when the mains or the external power source is applied, then U4MC34063 does not operate and the LED lamp does not emit light. Q7 is turned on when no external voltage is applied, and this voltage is divided through R16 and R17 then is applied to the eighth and seventh pin of U4MC34063. T3 is an energy storage inductor. R25 is an adjustable resistor for changing the value of the output voltage. C10 is an external capacitor of the unsteady-state oscillator in the IC. The oscillator outputs to Q6 via the second pin of the IC. Q6 functions as a switch tube to cooperate with T3 for rising the voltage. After rectified by D8 and filtered by C9, a stable DC voltage is output. Typical no. of LEDs to be used may be 10 or 20.

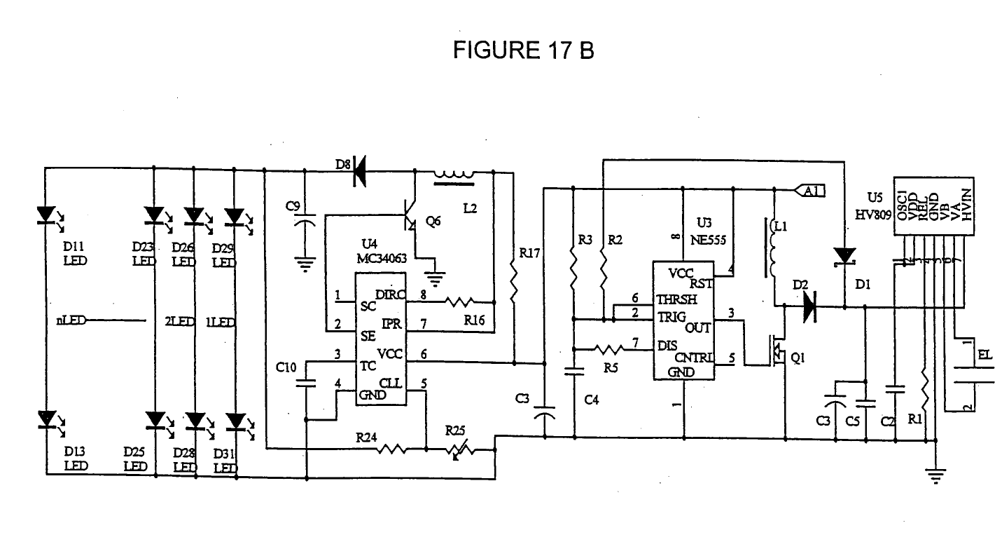

FIG. 17 is a system diagram showing the details of the whole emergency lighting circuit.

The emergency lighting circuit comprises five portions:

1. The pulsating constant current charging circuit (referring to FIG. 8);

2. The mains-fault detecting circuit (referring to FIG. 9);

3. The EL drive circuit (referring to FIG. 10-15);

4. The LED drive circuit (referring to FIG. 16); 5. The power circuit (referring to FIG. 7).

The emergency lighting circuit of the present invention is greatly reduced in size compared with the prior art because the size of the pulsating constant current charging circuit, the mains-fault detecting circuit, the EL drive circuit and the power circuit which constitute the emergency lighting circuit are smaller than that of the prior art.

In addition, in order to improve applicability in various circumstances and conditions, external or interior power source may be employed in this invention. It also has advantages of small size, convenient installation, low cost, stable performance and safe and high reliability.

The integrated device of the cold light emergency lamp and the cold light fire exit sign in the present invention is superior in cost and performance when compared with that of the existing emergency lighting devices.

Since the LED is employed as the cold light source of the emergency lamp, the emergency lamp has a simple design, small size and high reliability.

The EL material and the screen printing technology are used in the exit sign, resulting in a simple configuration and low cost. AC is used to directly drive electroluminescent sheet to emit light.

All the exit signs and the LED lamps are respectively connected to the centralized control box via their power lines, i.e. they are connected in parallel with each other, so disconnection of a single exit sign or LED lamp does not affect the normal illumination of other exit signs or LED lamps. Moreover, it is most reliable to use a switch power technology for controlling the brightness of LED.

The exit signs or the LED lamps are connected to the centralized control box via power lines so that they do not need electronic parts inside except the LED itself. Therefore, the exit signs or the LED lamps have excellent flexibility for installation, for example, each of them can be randomly mounted by adjusting the length of the power line according to installation conditions, i.e. they can not only arbitrarily rotate in the same horizontal level but also arbitrarily change angles and positions according to installation requests.

Since the electroluminescent sheet or the LED is used as the lighting source of the exit sign or the emergency lamp, the circuit design of the circuit of the control circuit in the centralized control box can be greatly improved.

In conclusion, the present invention provides an integrated device of cold light emergency lamp and cold light fire exit sign, which replaces the conventional large and heavy emergency lighting device, simplifies the process of installation and maintenance while cost and reliability are improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. The scope of invention does not limit to the embodiments. The scope of the invention should be defined by the appended claims.

What is claimed is:

1. A centralized control box comprising:
a plurality of sockets arranged on the body of the centralized control box for being inserted by power line plugs of a plurality of cold light exit signs and/or cold light emergency lamps;
a battery;
a cold light element drive circuit; and
a micro control unit connected to the battery for regularly detecting the battery at predetermined time and to the cold light element drive circuit for controlling the cold light element drive circuit;
wherein the cold light element drive circuit is electrically connected to the cold light exit signs and the cold light emergency lamps for driving the cold light exit signs and the cold light emergency lamps to emit light under the control of the micro control unit, when the power line plugs are inserted in the sockets.

2. The centralized control box according to claim 1, wherein:
the centralized control box is also provided with a testing switch, a fuse tube and indicating devices respectively for indicating the operation states of the mains voltage, the battery, the cold light exit signs and the cold light emergency lamps.

3. The centralized control box according to claim 2, wherein:
the micro control unit detects and controls the charge time and discharge time of the battery via a crystal oscillator, detects the voltage and current of each of the cold light exit signs and the cold light emergency lamps via an A/D converting circuit, indicates the cold light element operation state of each of the cold light exit signs and the cold light emergency lamps via the indicating light according to a preset program, regularly detects the battery and the cold light element operation condition via a read only memory storing a timing program and controls the cold light element drive circuit at predetermined time.

4. The centralized control box according to claim 2, wherein:
the battery is a nickel-cadmium battery or a nickel-metal hydride battery; and
the indicating device is a LED or a backlight liquid crystal display unit.

5. The centralized control box according to claim 1, wherein:
the cold light element drive circuit is an IC type DC-AC converting circuit.

6. The centralized control box according to claim 5, wherein:
the IC type DC-AC converting circuit is an integrated circuit for driving a large electroluminescent sheet, which directly rectifies the mains voltage to an AC voltage of 100-120V and 400-600 Hz so as to drive the large electroluminescent sheet to emit light.

7. The centralized control box according to claim 5, wherein:
the IC type DC-AC converting circuit is an integrated circuit for driving a medium electroluminescent sheet, which converts a DC voltage to a positive-negative symmetrical AC voltage of 80-100v and 400-600 Hz so as to drive the medium electroluminescent sheet to emit light.

8. The centralized control box according to claim 5, wherein:
the IC type DC-AC converting circuit is an integrated circuit for driving a small electroluminescent sheet, which converts a DC voltage to a positive AC voltage of approximately triangular with a voltage peak of 100-130V and a frequency of 400-600 Hz so as to drive the small electroluminescent sheet to emit light.

9. The centralized control box according to claim 5, wherein:
the IC type DC-AC converting circuit is an integrated circuit for driving a LED, which converts a low DC voltage to a voltage that is suitable for driving LED to emit light with a high chopping frequency of above 20 kHz.

10. A cold light exit sign, comprising:
a power line plug used for inserting in a socket of a centralized control box so as to electrically connect the cold light exit sign with a cold light element drive circuit in the centralized control box;
wherein the cold light exit sign does not comprise any other electronic parts except for cold light elements.

11. The cold light exit sign according to claim 10, wherein:
the cold light exit sign includes a sign plate carrying the power line plug, and a light baffle-board with a plurality of LEDs arranged behind the sign plate.

12. The cold light exit sign according to claim 11, wherein:
said plurality of LEDs are arranged in a row on an upper side or a lower side of the light baffle-board if the area of the cold light exit sign is small.

13. The cold light exit sign according to claim 11, wherein:
said plurality of LEDs are arranged in two rows respectively on an upper side and a lower side of the light baffle-board if the area of the cold light exit sign is medium.

14. The cold light exit sign according to claim 11, wherein:
said plurality of LEDs are arranged in four rows respectively on an upper side, a lower side and two sides of the light baffle-board if the area of the cold light exit sign is large.

15. The cold light exit sign according to claim 10, wherein:
the luminescent portion of the cold light exit sign is an electroluminescent sheet with the power line plug.

16. The cold light exit sign according to claim 15, wherein:
the electroluminescent sheet is printed with one of pattern and character made from an electroluminescent powder or their combination.

17. A cold light emergency lamp, comprising:
a power line plug used for inserting in a socket of a centralized control box so as to electrically connect the cold light emergency lamp with a cold light element drive circuit in the centralized control box;
wherein the cold light emergency lamp does not comprise any other electronic parts except for cold light elements.

18. The cold light emergency lamp according to claim 17, wherein:
the cold light emergency lamp is provided with only a LED encapsulation.

19. The cold light emergency lamp according to claim 18, wherein:
the LED encapsulation includes a LED directly spot-welded on a circuit board in the form of a chip and enveloped with a phosphor powder and a transparent epoxy resin therein.

20. An apparatus integrated with cold light emergency lamp and cold light exit sign, comprising:
a centralized control box including a plurality of sockets arranged on the body thereof for being inserted by power line plugs of one or more of cold light exit signs and/or one or more of cold light emergency lamps; a battery; a cold light element drive circuit; and a micro control unit connected to the battery for regularly detecting the battery at predetermined time and to the cold light element drive circuit for controlling the cold light element drive circuit; and
one or more groups of cold light emergency lamps and cold light exit signs placed on the area away from the centralized control box and carrying power line plugs for inserting in sockets of the centralized control box, wherein the cold light emergency lamps and the cold light exit signs do not comprise any other electronic parts except for cold light elements;
wherein the cold light element drive circuit is electrically connected to the cold light exit signs and the cold light emergency lamps for driving the cold light exit signs and the cold light emergency lamps to emit light under the control of the micro control unit, when the power line plugs are inserted in the sockets.

21. The apparatus according to claim 20, wherein:
the centralized control box is also provided with a testing switch, a fuse tube and indicating devices respectively for indicating operation states of the mains voltage, the battery, and the cold light exit signs and the cold light emergency lamps.

22. The apparatus according to claim 21, wherein:
the micro control unit detects and controls the charge time and discharge time of the battery via a crystal oscillator, detects the voltage and current of each of the cold light exit signs and the cold light emergency lamps via an A/D converting circuit, indicates the cold light element operation state of each of the cold light exit signs and the cold light emergency lamps via the indicating light according to a preset program, regularly detects the battery and the cold light element operation condition via a read only memory storing a timing program and controls the cold light element drive circuit at predetermined time.

23. The apparatus according to claim 21, wherein:
the battery is a nickel-cadmium battery or a nickel-metal hydride battery; and
the indicating device is a LED or a backlight liquid crystal display unit.

24. The apparatus according to claim 20, wherein:
the cold light element drive circuit is an IC type DC-AC converting circuit.

25. The apparatus according to claim 24, wherein:
the IC type DC-AC converting circuit is an integrated circuit for driving a large electroluminescent sheet, which directly rectifies the mains voltage to an AC voltage of 100-120V and 400-600 Hz so as to drive the large electroluminescent sheet to emit light.

26. The apparatus according to claim 24, wherein:
the IC type DC-AC converting circuit is an integrated circuit for driving a medium electroluminescent sheet, which converts a DC voltage to a positive-negative symmetrical AC voltage of 80-100v and 400-600 Hz so as to drive the medium electroluminescent sheet to emit light.

27. The apparatus according to claim 24, wherein:
the IC type DC-AC converting circuit is an integrated circuit for driving a small electroluminescent sheet, which converts a DC voltage to a positive AC voltage of approximately triangular with a voltage peak of 100-130V and a frequency of 400-600 Hz so as to drive the small electroluminescent sheet to emit light.

28. The apparatus according to claim 24, wherein:
the IC type DC-AC converting circuit is an integrated circuit for driving a LED, which converts a low DC voltage to a voltage that is suitable for driving LED to emit light with a high chopping frequency of above 20 kHz.

29. The apparatus according to claim 20, wherein:
the cold light exit sign includes a sign plate carrying the power line plug and a light baffle-board with a plurality of LEDs arranged behind the sign plate.

30. The apparatus according to claim 29, wherein:
said plurality of LEDs are arranged in a row on an upper side or a lower side of the light baffle-board if the area of the cold light exit sign is small.

31. The apparatus according to claim 29, wherein:
said plurality of LEDs are arranged in two rows respectively on an upper side and a lower side of the light baffle-board if the area of the cold light exit sign is medium.

32. The apparatus according to claim 29, wherein:
said plurality of LEDs are arranged in four rows respectively on an upper side, a lower side and two sides of the light baffle-board if the area of the cold light exit sign is large.

33. The apparatus according to claim 20, wherein:
the luminescent portion of the cold light exit sign is an electroluminescent sheet with the power line plug.

34. The apparatus according to claim 33, wherein:
the electroluminescent sheet is printed with one of pattern and character made from an electroluminescent powder or their combination.

35. The apparatus according to claim 34, wherein:
the cold light emergency lamp is provided with only a LED encapsulation.

36. The apparatus according to claim 35, wherein:
the LED encapsulation includes a LED directly spot-welded on a circuit board in the form of chip and enveloped with a phosphor powder and a transparent epoxy resin therein.
